(19) United States
(12) Patent Application Publication
(10) Pub. No.: US 2025/0307040 A1
(43) Pub. Date: Oct. 2, 2025

(54) MANAGING DATA OUTPUT OF A WORKFLOW

(71) Applicant: Beijing Zitiao Network Technology Co., Ltd., Beijing (CN)

(72) Inventor: Xuneng Huang, Beijing (CN)

(21) Appl. No.: 18/767,119

(22) Filed: Jul. 9, 2024

(30) Foreign Application Priority Data
Mar. 29, 2024 (CN) 2024103824543

(51) Int. Cl. G06F 9/54

(52) U.S. Cl. CPC G06F 9/546

(57) ABSTRACT

According to embodiments of the disclosure, a method, an apparatus, a device, and a media for managing data output of workflows are provided. The method includes: adding a message node instance corresponding to a message node to the workflow in response to receiving a selection request for the message node in a page used to create the workflow, wherein the message node specifies one or more messages output by the workflow; and presenting the message node instance in the page, wherein the message node instance includes an input end and an output end, the input end is used to receive the message to be output, and the output end is used to specify that the message is presented in a predetermined format by the workflow. In this way, multifaceted messages may be provided in a more understandable format, thereby providing richer output content.

### CROSS-REFERENCE

The present application claims priority to Chinese Patent Application No. 202410382454.3, filed on Mar. 29, 2024 and entitled “METHOD, APPARATUS, DEVICE AND MEDIA FOR MANAGING DATA OUTPUT OF A WORKFLOW”, the entirety of which is incorporated herein by reference.

### FIELD

The example implementations of the present disclosure relate generally to the computer field, and in particular for managing data output of a workflow.

### BACKGROUND

Digital assistants are provided to assist users in various task processing needs in different applications and scenarios. Digital assistants often have capabilities of intelligent conversation and task processing. During interaction with the digital assistant, the user enters interaction messages, and the digital assistant provides reply messages in response to the user input. Generally, digital assistants can support users to input questions in natural language, and perform tasks and provide replay based on the understanding of the natural language input and logical reasoning capabilities of the digital assistants. However, digital assistants usually output all reply messages at once, and larger reply messages lack hierarchical structure. This makes it difficult for users to quickly understand the summary of the reply message, and they need to read it word by word to grasp the structure and specific content of the reply message.

### SUMMARY

In a first aspect of the present disclosure, a method for managing data output of a workflow is provided. The method comprises: adding a message node instance corresponding to a message node to the workflow in response to receiving a selection request for the message node in a page used to create the workflow, wherein the message node specifies one or more messages output by the workflow; and presenting the message node instance in the page, wherein the message node instance includes an input end and an output end, and wherein the input end is used to receive the message to be output, and the output end is used to specify that the message is presented in a predetermined format by the workflow.

In a second aspect of the present disclosure, an apparatus for managing data output of workflows is provided. The apparatus comprises: an instance adding module configured to add a message node instance corresponding to the message node to the workflow in response to receiving a selection request for a message node in a page used to create the workflow, wherein the message node specifies the message output by the workflow; and an instance presenting module configured to present the message node instance in the page, wherein the message node instance includes an input end and an output end, and wherein the input end is used to receive a message to be output, and the output end is used to specify that the message is presented in a predetermined format by the workflow.

In the third aspect of the present disclosure, an electronic device is provided. The electronic device comprises: at least one processing unit; and at least one memory coupled to the at least one processing unit and storing instructions executed by the at least one processing unit, the instructions when executed by the at least one processing unit causes the electronic device to perform the method according to the first aspect of present disclosure.

In the fourth aspect of the present disclosure, a computer-readable storage medium having a computer program stored thereon is provided. When executed by a processor, the computer program causes the processor to perform operations that implement the method according to the first aspect of present disclosure.

According to a fifth aspect of present disclosure, a computer program product comprising a computer program is provided, wherein the computer program when executed by a processor causes the processor to perform operations that implement a method according to the first aspect of present disclosure.

It should be understood that what is described in this section is not intended to limit key features or important features of implementations of the disclosure, nor is it intended to limit the scope of the disclosure. Other features of the disclosure will become apparent from the description below.

### BRIEF DESCRIPTION OF THE DRA WINGS

The above and other features, advantages and aspects of various embodiments of the present disclosure will become more apparent with reference to the following detailed description taken in conjunction with the accompanying drawings. In the drawings, the same or similar reference numbers represent the same or similar elements, where:

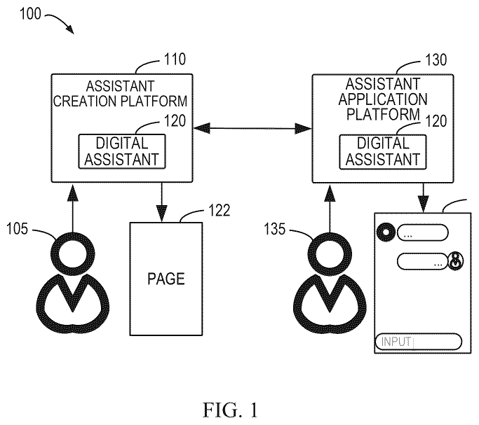

FIG. 1 shows a schematic diagram of an example environment.

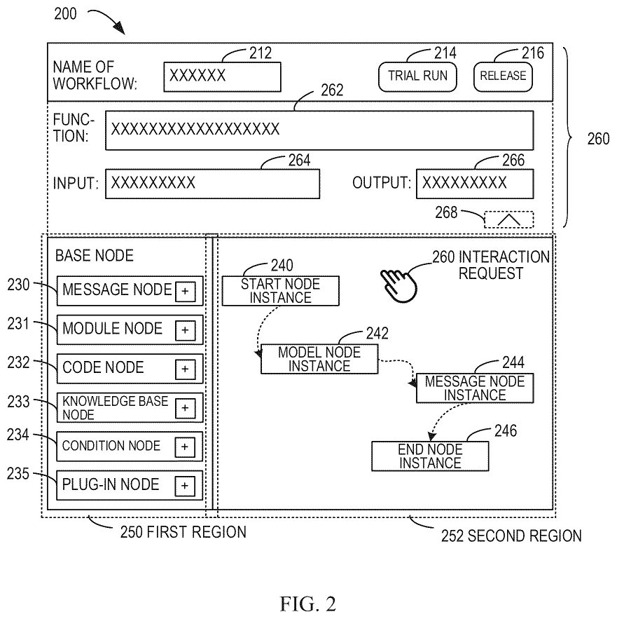

FIG. 2 shows a schematic diagram of an example of a workflow management page.

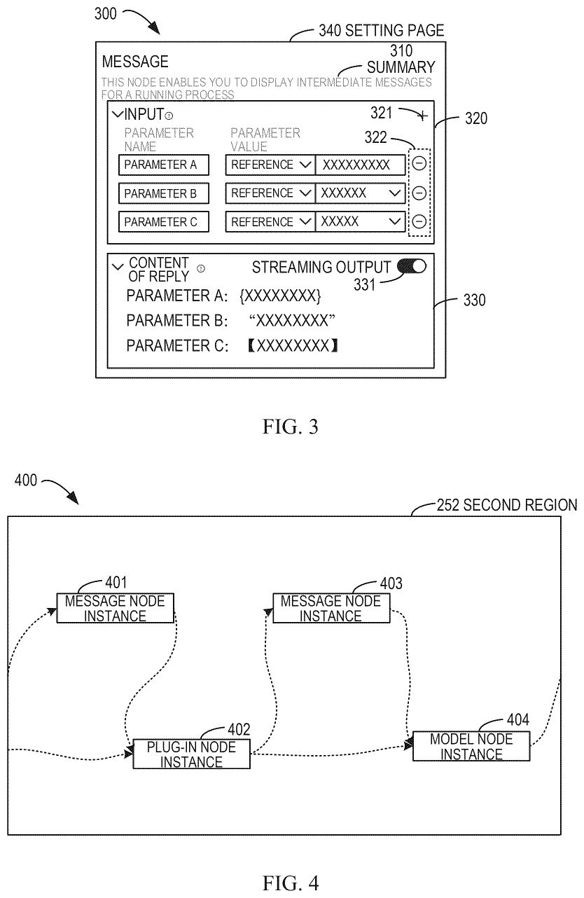

FIG. 3 shows a block diagram of an example message node instance in a workflow.

FIG. 4 illustrates a block diagram of an example workflow including a plurality of node instances.

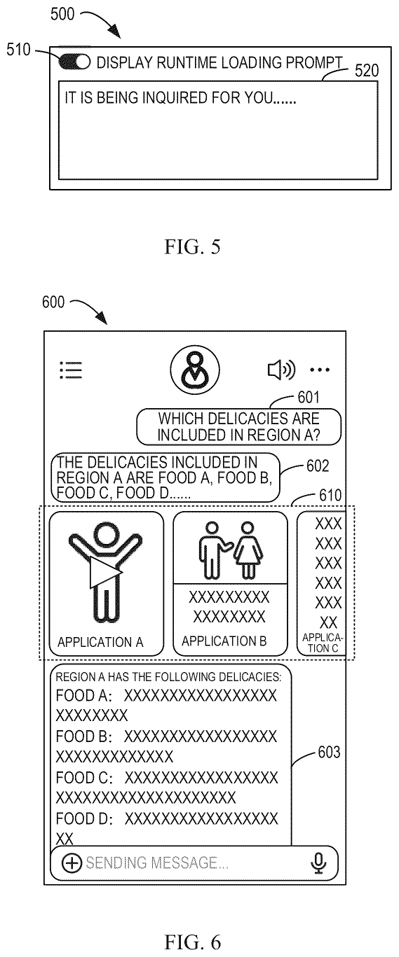

FIG. 5 illustrates a schematic diagram of an example of a setting control for presentation attributes.

FIG. 6 shows a schematic diagram of an example page.

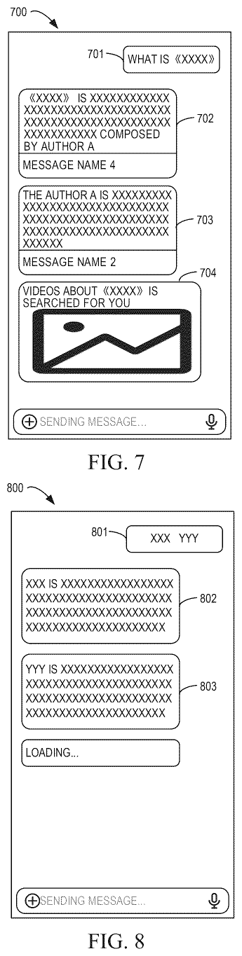

FIG. 7 shows a schematic diagram of an example page.

FIG. 8 shows a schematic diagram of an example page.

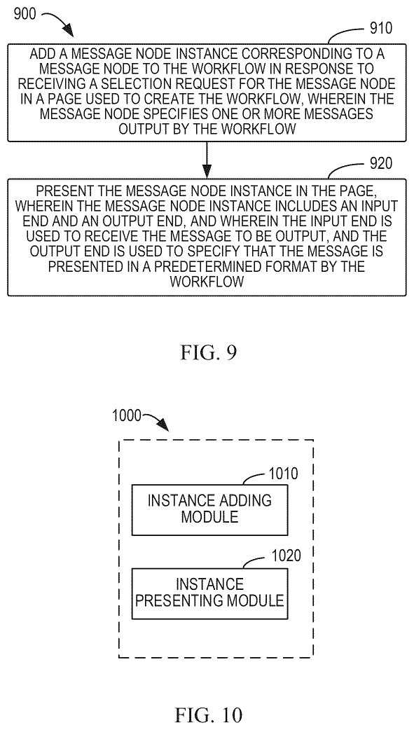

FIG. 9 illustrates a flow diagram of an example process for managing data output of workflow.

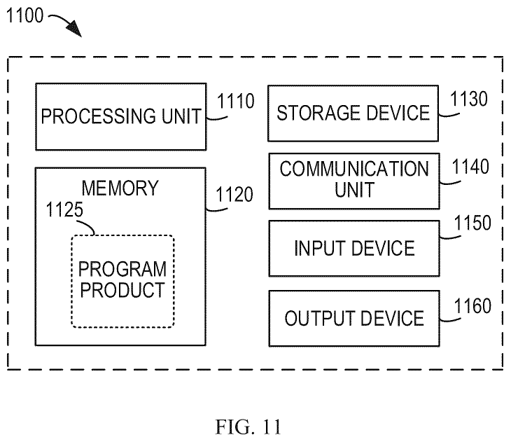

FIG. 10 shows a structural schematic block diagram of an example apparatus for managing data output of a workflow.

FIG. 11 shows a block diagram of an example electronic device in which one or more embodiments of the present disclosure may be implemented.

### DETAILED DESCRIPTION

Embodiments of the present disclosure will be described in more detail below with reference to the accompanying drawings. Although certain embodiments of the disclosure are shown in the drawings, it should be understood that the disclosure may be embodied in various forms and should not be construed as limited to the embodiments set forth herein, but rather, these embodiments are provided for providing a thorough and complete understanding of this disclosure. It should be understood that the drawings and embodiments of the present disclosure are for illustrative purposes only and are not intended to limit the scope of the present disclosure.

In the description of embodiments of the present disclosure, the term “including” and similar expressions shall be understood as an open-ended inclusion, that is, “including but not limited to”. The term “based on” should be understood to mean “based at least in part on”. The term “an embodiment” or “the embodiment” shall be understood to mean “at least one embodiment”. The term “some embodiments” should be understood as “at least some embodiments”. Other explicit and implicit definitions may be included below.

Unless explicitly stated, performing a step “in response to A” does not mean that the step is performed immediately after “A” but may include one or more intermediate steps.

It should be understood that the data involved in this technical solution (including but not limited to the data itself, the acquisition, use, storage or deletion of the data) should comply with the requirements of corresponding laws, regulations and relevant regulations.

It can be understood that before using the technical solutions disclosed in each embodiment of this disclosure, relevant users should be informed of the type, scope of use, usage scenarios, etc. of the information involved in this disclosure through appropriate methods in accordance with relevant laws and regulations, and authorization from the relevant users should be obtained, where relevant users can include any type of rights subject, such as individuals, businesses, and groups.

For example, in response to receiving an active request from a user, prompt information is sent to the relevant user to clearly remind the relevant user that the operation requested will require and use the relevant user's information, so that the relevant user can follow the prompt information autonomously chooses whether to provide information to software or hardware such as electronic devices, applications, servers, or storage media that perform operations of the disclosed technical solution.

As an optional, but non-limiting, embodiment, in response to receiving an active request from a relevant user, a way of sending prompt information to the relevant user, for example, can be in the form of a pop-up window, and the prompt information may be presented in the form of text in the pop-up window. In addition, the pop-up window may also carry a selection control for the user to select “agree” or “disagree” to provide information to the electronic device.

It can be understood that the above notification and user authorization processes are only illustrative and do not limit the embodiments of this disclosure. Other ways that meet relevant laws and regulations can also be applied to the embodiments of this disclosure.

As used in this application, the term “model” can learn the association relationship between the corresponding input and output from the training data. The corresponding output can be generated for the given input after the training is completed. Model generation can be based on machine learning techniques. Deep learning is a machine learning algorithm that uses multiple layers of processing units to process inputs and provide corresponding outputs. Neural network models are an example of deep learning-based models. Herein, a “model” may also be called a “machine learning model,” “learning model,” “machine learning network,” or “learning network”, and these terms are used interchangeably in this description.

Digital assistants can be used as tools for people to effectively work, study, and live. Generally, the development of digital assistants is similar to the development of general applications. Developers with programming capabilities need to write complex codes to define the capabilities of the digital assistant, and deploy the digital assistant on an appropriate operating platform so that users can download, install and use digital assistants.

With the diversification of application scenarios and the increasing availability of machine learning technology, more digital assistants may be developed with different capabilities to support task processing in various segments, or to meet the personalized needs of different users. However, because of limitations in individual user's programming capabilities and limited understanding of the underlying implementation logic of digital assistants, users cannot create different digital assistants freely and conveniently. Therefore, this specification describes technologies configured to provide a more convenient and flexible way to create digital assistants, allowing more users to configure the digital assistants they want.

### Example Environment

By providing a modular, simple and freely input digital assistant creation solution, users can easily and quickly define digital assistants with different capabilities without requiring coding skills.

FIG. 1 shows a schematic diagram of an example environment 100 in which embodiments of the present disclosure can be implemented. Environment 100 involves an assistant creation platform 110 and an assistant application platform 130.

As shown in FIG. 1, the assistant creation platform 110 may provide a user 105 (e.g., user who creates digital assistants) with an environment in which a digital assistant may be created and released. In some embodiments, the assistant creation platform 110 may be a low-code platform that provides a collection of tools for creating digital assistants. The assistant creation platform 110 may support the visual development of digital assistants, thereby allowing developers to skip the manual coding process and speed up the application development cycle and cost. The assistant creation platform 110 may be any suitable platform that supports a user in developing digital assistants and other types of applications, and may include, for example, application platform as a service (aPaaS) based platforms. Such a platform can support a user to efficiently develop applications and implement operations such as application creation and application function adjustment.

The assistant creation platform 110 may be deployed locally on the user's 105 terminal device, and/or may be supported by a remote server. For example, the terminal device of the user 105 may run a client (e.g., an application) in communication with the assistant creation platform 110, and the client may support the interaction between the user and the assistant creation platform 110. When the assistant creation platform 110 runs locally on the user's terminal device, the user 105 may directly interact with the local assistant creation platform 110 using the client. When the assistant creation platform 110 runs on a server device, the server device may provide services to the client running on the terminal device based on the communication connection between the assistant creation platform 110 and the terminal device. The assistant creation platform 110 may present corresponding pages 122 to the user 105 based on the user's 105 operations to output and/or receive information to/from the user 105.

In some embodiments, the assistant creation platform 110 may be associated with a corresponding database that stores data or information required for the digital assistant creation process supported by the assistant creation platform 110. For example, the database may store codes and description information corresponding to each functional module that constitutes the digital assistant. The assistant creation platform 110 can also perform operations, such as calling, adding, deleting, and updating, on functional modules in the database. The database may also store operations that can be performed on different functional modules. For example, in a scenario where an application 150 is to be created, the assistant creation platform 110 may call corresponding function blocks from the database to build the application 150.

In some embodiments of the present disclosure, the user 105 may create a digital assistant 120 as needed on the assistant creation platform 110 and release the digital assistant 120. The digital assistant 120 may be released to any suitable assistant application platform 130, as long as the assistant application platform 130 is capable of supporting the operation of the digital assistant 120. After being released, the digital assistant 120 may be used for conversational interaction with user 135. The client of the assistant application platform 130 may present the interaction window 132 of the digital assistant 120 in the client interface, such as a session window. As an intelligent assistant, the digital assistant 120 has intelligent conversation and information processing capabilities. The user 140 may enter a session message in the session window, and the digital assistant 120 may determine a reply message based on the created configuration information and present it to the user in the interaction window 132. In some embodiments, depending on the configuration of digital assistant 120, interaction messages with digital assistant 120 may include messages in multiple message formats, such as text messages (e.g., natural language text), voice messages, image messages, video messages, etc.

The assistant creation platform 110 and/or assistant application platform 130 may run on appropriate electronic devices. The electronic device may be any suitable type of device with computing capabilities, including terminal device or server device. The terminal device may be any type of mobile terminal, fixed terminal or portable terminal, including mobile phone, desktop computer, laptop computers, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, e-book device, gaming device, or any combination of the foregoing, including accessories and peripherals for these devices or any combination thereof. The server device may include, for example, a computing system/server such as a mainframe, edge computing node, computing device in cloud environment, and the like. In some embodiments, the assistant creation platform 110 and/or the assistant application platform 130 may be implemented based on cloud service.

It should be understood that the structure and function of environment 100 are described for illustrative purposes only and do not imply any limitation on the scope of the present disclosure.

The assistant creation platform 110 may obtain interaction information between the user 105 and the digital assistant 120 in the session window (including session messages from the user and reply messages from the digital assistant 120). In some embodiments, the assistant creation platform 110 may use models to understand the user's session messages and determine the next action to take. The assistant creation platform 110 may interact with the model to provide model input to the model and obtain corresponding model output from the model. The model may be run locally on the assistant creation platform 110 or on a remote server. In some embodiments, the model may be a machine learning model, a deep learning model, a learning model, a neural network, etc. In some embodiments, the model may be based on language models, or other models known in the past and/or to be developed in the future. The language models may have question-answering capabilities by learning from a large amount of corpus. Models may also be based on other suitable models.

In the context of this disclosure, the workflows may be used to handle more complex tasks. In summary, the workflow may define multiple sequential operations in predetermined tasks, and may implement each sequential operation based on a modular approach to complete the predetermined tasks. The workflow may invoke the functions of various predetermined nodes (for example, model nodes, plug-in nodes, etc.) to complete predetermined tasks.

However, the workflow usually takes a long time to execute. As a result, during the running of the digital assistant including the workflow, the digital assistant may not be able to provide a reply for a long time. This can result in the user being in a state of waiting for feedback from the digital assistant for a long time. In addition, the digital assistant usually outputs all reply messages at once, and larger reply messages lack hierarchical structure. Thus, it is difficult for users to quickly understand the summary of the reply message, and they need to read it word by word to grasp the structure and specific content of the reply message. This specification describes technologies such that, when interacting with a digital assistant, structured reply messages can be provided in a more reasonable manner and that users can obtain desired reply in a more convenient and effective manner.

### Summary of Management of Data Output of Workflows

In order to at least partially solve the deficiencies in the prior art, according to some example embodiments of the present disclosure, a method for managing data output of a workflow in an application environment for creating a digital assistant is proposed. In summary, the message node may be used to specify one or more messages output by the workflow in the desired format. Specifically, new functions may be provided using workflows in the assistant creation platform 110. Workflows may define multiple sequential operations in predetermined tasks, and may implement each sequential operation based on a modular approach to complete the predetermined tasks. Multiple nodes of a workflow include a message node, which specifies one or more messages output by the workflow. According to an example embodiment of the present disclosure, the message node may be used in a workflow to present a message to the user before the end of the workflow. In this way, multifaceted replies to user questions may be provided in a more understandable format. Furthermore, users do not have to wait for a long time for the final reply of the workflow, but may use message nodes to gradually obtain partial replies. Therefore, the “one question, multiple replies” presentation may help improve the efficiency of providing information.

In some embodiments, a message node instance corresponding to a message node is added to the workflow in the page used to create the workflow, in response to receiving a selection request for the message node, wherein the message node specifies the message output by the workflow. Further, a message node instance may be presented in the page. The message node instance includes an input end and an output end. The input end is used to receive the message to be output, and the output end is used to specify that the message is presented in a predetermined format by the workflow.

An overview of an exemplary embodiment according to the present disclosure is described with reference to FIG. 2, which shows a schematic diagram of an example 200 of a workflow management page according to some embodiments of the present disclosure. As shown in FIG. 2, in the assistant creation platform 110, a workflow management page as shown in example 200 may be provided.

Specifically, a user request may be detected in the assistant creation platform 110. Upon receipt of a creation request, the example 200 for creating a workflow may be presented. For example, a control (e.g., menu, button, etc.) for launching example 200 may be provided, and a creation request may be detected based on the interaction between the user and the control.

In FIG. 2, example 200 may include multiple regions. For example, in upper region 260 of example 200, a name of the workflow may be presented, which may be entered by the user in control 212. The control 214 may provide a trial run function, and the user may press the control 214 to run the created workflow and test whether the results of the workflow meet expectations. In some embodiments, at least one input data provided to the workflow may be received in response to receiving a test request for testing the workflow (e.g., a trigger operation for control 214).

During the testing process, relevant state data of each node instance in the workflow may be provided to the user. For example, the user may double-click the node instance desired to view in order to obtain relevant state data. Alternatively and/or additionally, relevant state data may be provided when the user's mouse hovers over a node instance, etc. It should be understood that the state data here may include, for example, data at the input end of the message node instance, and/or data at the output end of the message node instance.

The control 216 may provide a releasing function. For example, the user may press the control 216 to release the created workflow in the assistant creation platform 110, or integrate the created workflow into the digital assistant 120 currently being created, and so on. The workflow may be released directly in multiple environments (e.g., multiple applications). The workflow may also be released in multiple environments along with the digital assistant 120 after being integrated into the digital assistant 120.

According to an example implementation of the present disclosure, the upper region 260 may present description information about the workflow. For example, the functionality of the workflow may be presented at control 262, the input data of the workflow may be presented at control 264, the output data of the workflow may be presented at control 266, and so on. Further, the user may press control 268 to collapse the description information shown in the dotted box in upper region 260. In this way, the lower two regions may be displayed in a larger range, thus facilitating user interaction.

Further, the lower part of the example 200 may include: a first region 250 on the left and a second region 252 on the right. Specifically, the first region 250 may provide a plurality of different types of nodes that are allowed to be added to the workflow. The plurality of nodes here may include a message node (e.g., message node 230 in FIG. 2) that specifies a message to be output by the workflow. The user request in the first region 250 may be detected. For example, in response to receiving a selection request for message node 230, a message node instance corresponding to the message node may be added to the workflow.

On the right of the first region 250, a second region 252 for providing content of the workflow may be presented. During the initial stages of creating a workflow, the second region 252 may be empty. The user's interaction request in example 200 may be continuously detected, and the workflow may be managed based on the interaction request 260. For example, with the adding operations by the user, the second region 252 may gradually present instances of each node added to the workflow (e.g., simply referred to as node instances).

In some embodiments, a message node instance (e.g., message node instance 244) corresponding to a message node 230 is added to the workflow, in response to receiving a selection request for the message node 230 (for example, it may be determined that a selection request for the message node 230 is received in response to receiving a trigger operation on the message node 130). Alternatively and/or additionally, the user may add the message node instance directly in the second region 252. For example, the user may right-click in the second message region 252 to present various nodes that may be added. At this time, in response to receiving an adding request to add a node to the workflow in the second region of the page, various nodes (for example, a message node, a model node, a plug-in node, etc.) may be presented.

The message node instance 244 includes an input end for receiving messages from upstream, and an output end for specifying the presentation of messages in a predetermined format by the workflow. The predetermined format may be a preset format. In some embodiments, the workflow may also include one or more data acquisition node instances corresponding to the data acquisition nodes (for example, a model node instance corresponding to model node 231, a plug-in node instance corresponding to plug-in node).

For example, the workflow may include a start node instance 240, an end node instance 246, and one or more node instances between the start node instance 240 and the end node instance 244 (e.g., model node instance 242 corresponding to model node 231, message node instance 244 corresponding to message node 230). The input end of the message node instance 244 may be used to receive the message output by the model node instance 242 (such as a text message generated by invoking the model), and the output end of the message node instance 244 may be used to specify that the message is presented in a predetermined format by the workflow. At this time, the message node instance 244 may serve as a supplement to the information output by the end node instance 246, and present replies to the input questions from multiple perspectives.

In some embodiments, the message node instance 244 is located upstream of the end node instance 246. If the workflow is used to process the query request and generate a reply to the processing request, the message node instance 244 may be configured to specify a first reply to the query request output by the workflow, and the end node instance 246 may be configured to specify a second reply to the query request output by the workflow, wherein this second reply is generated based on the first reply (for example, the second reply may be a summary of the first reply). That is, before the workflow completes the processing of the query request, the message node instance 244 may output an intermediate reply (i.e., the first reply), and after the workflow completes the processing of the query request, the end node instance 246 presents the second reply. For example, if the query request indicates to query the delicacies of region A, the first reply may include which delicacies are included in region A, and the second reply may include a detailed introduction to each delicacy included in region A.

In some embodiments, a default initial workflow may be provided when the user creates the workflow. At this time, the second region 252 may present various node instances in the default initial workflow. For example, a default initial workflow may include required node instances (e.g., a start node instance and an end node instance), and may also include workflow instances that are typically invoked (e.g., model node instances). At this point, users do not have to manually add these node instances, but may make adjustments based on the default initial workflow. In this way, the complexity of user operations can be further simplified, thereby improving creation efficiency.

Therefore, when processing a query request with the help of a workflow, multiple messages may be presented using message nodes before the processing of query request is completed, and the reply finally generated by the workflow may be a summary of these multiple messages. This can realize “one question, multiple replies”, enrich the content obtained by the users, and improve the efficiency of users' obtaining replies.

### Detailed Process of Managing Data Output of Workflow

Having described an outline of one example embodiment according to the present disclosure, in the following, more details of the workflow management page will be described with continued reference to FIG. 2. In the context of this disclosure, “manage workflow” may include multiple forms. For example, example 200 may be used to create a new workflow, or this page may be used to open and modify an existing workflow.

It should be understood that nodes may be considered as “functional blocks” used to implement one or more basic functions, thereby allowing users to utilize multiple “functional blocks” to achieve desired functions. With the example embodiments of the present disclosure, multiple types of nodes are allowed to be inserted into the workflow, thereby facilitating users to achieve desired functions with richer development ways.

In some embodiments, the workflow may, by default, include a start node instance 240 corresponding to the start position of the workflow and an end node instance 246 corresponding to the end position of the workflow. Alternatively and/or additionally, the user may add the start node instance 240 and the end node instance 246 to the workflow themselves.

In some embodiments, a user's selection request for a target node among multiple nodes may be detected. In the event that the selection request is detected, a target node instance corresponding to the target node may be added to the workflow. For example, the user may add the target node instance through the right-click menu. Specifically, when the user's input focus is located in the second region 252, the user may right-click the input device (for example, a mouse, etc.), and then select the node type desired to be added in the pop-up menu. In embodiments of the present disclosure, a message node instance corresponding to the message node may be added to the workflow in response to receiving a selection request for the message node. For example, the user may select message node 230 from the menu to add message node instance 244 to the workflow. Alternatively and/or additionally, nodes may be inserted into the workflow in other ways, for example, a node in the first region 250 may be dragged to the second region 252, or icon “+” in the first region 250 may be clicked to complete the adding process.

It should be understood that the second region 252 is used to present specific content in the workflow, so the second region 252 will be updated synchronously as the node instances in the workflow change. For example, after the message node instance 244 corresponding to the message node is added to the workflow, the message node instance 244 may be presented in the second region in the page.

In some embodiments, the message node specifies the message output by the workflow. A message node instance includes an input end and an output end. The input end is used to receive the message to be output, and the output end is used to specify that the message is presented in a predetermined format by the workflow. More details regarding message node instance 244 are described with reference to FIG. 3, which shows a block diagram 300 of a message node instance in a workflow according to some embodiments of the present disclosure. As shown in FIG. 3, a settings page 340 may be provided to set the specific content of the message node instance 244, and the summary 310 can represent general information of the message node instance 244, such as the name “Message” and the main functions of the node instance. Further, a region 320 for setting the input end and a region 330 for setting the output end may be provided. In region 320, a control 321 may be presented. The user may add new input parameters to the message node instance 244 by triggering the control 321. Each input parameter may correspond to one input end. For example, the input parameters may include: “parameter A”, “parameter B”, and “parameter C”. For example, parameter A may correspond to input end A, parameter B may correspond to input end B, and parameter C may correspond to input end C. The user may press control 322 to delete one or more input parameters from the message node instance 244 (i.e., delete one or more input ends).

Further, a region 330 may present an edit dialog box for input parameters in order to set a predetermined format for presenting the message. The predetermined format may be used, for example, to specify the font, font size, color, delimiters, and/or presentation region of the message. The predetermined format may also include an output mode, for example. The output mode may include, for example, a text stream mode and a text block mode. The text stream mode is to present the text message word by word until the complete text message is presented, and the text block mode is to directly present the complete text message. In some embodiments, a region 330 may include control 331. In response to receiving the opening operation of the control 331, it is determined the message is presented in a text stream mode (which may also be called streaming output). In response to receiving a close operation of the control 331, it may be determined that the message is presented in a text block mode (which may also be called non-streaming output). In this way, a user may be allowed to present the output information according to their own preferences.

In some embodiments, where the input end of the message node instance 244 includes multiple input ends (e.g., may include at least a first input end and a second input end), the predetermined format may include a format that specifies a first message from the first input end and the second message from the second input end. That is, the user may respectively configure the predetermined format for presenting the first message and the predetermined format for presenting the second message via the region 330. For example, the user may respectively configure the format for presenting the message from input end A, the format for the message from input end B, and the format for the message from input end C via the edit dialog box in region 330.

Alternatively and/or additionally, a predefined style template may be provided and the desired positions in the style template are filled with messages from input ends A, B and C respectively. In this way, the reply message may be presented with richer visual effect, thereby multifaceted information of the reply may be presented in a structured manner.

With the example embodiments of the present disclosure, the user may be allowed to configure message node instances 244 in a more convenient and efficient manner. In this way, it is possible to define in message node instance 244 which messages are received and in what format the received messages are presented.

In some embodiments, multiple nodes may also include multiple data acquisition nodes. The data acquisition node may include, for example, a model node (for example, the model mode 231 in FIG. 2) for invoking machine learning model (which may also be referred to as model) or a plug-in node (for example, the plug-in node 235 in FIG. 2) for invoking the plug-in function. In some embodiments, multiple nodes may also include a code node (for example, the code node 232 in FIG. 2) for providing the functionality of the code using node programming code, a knowledge base node (for example, the knowledge base node 233 in FIG. 2) for providing the function of the code node based on the research of the knowledge base, and/or a condition node (for example, the condition node 234 in FIG. 2) for providing the function of the condition node based on conditional determination.

In some embodiments, for the data acquisition node instance and the message node instance in the workflow, in response to receiving a connection request for connecting the output end of the data acquisition node instance and the input end of the message node instance, a connection relationship between the output end of the data acquisition node instance and the input end of the message node instance is established. More details are described with reference to FIG. 4, which illustrates a block diagram 400 of a workflow including multiple node instances in accordance with some embodiments of the present disclosure. As shown in FIG. 4, the workflow may include multiple message node instances (for example, message node instance 401 and message node instance 403, the input ends and output ends thereof are different). In the second region 252, the connection request of the user between the data acquisition node instance and the message node instance may be detected. According to an example embodiment of the present disclosure, the connection request may be defined in multiple ways, for example, the mouse connection operation by the user between two node instances may be detected, and the like.

If a connection request is detected between the output end of the plug-in node instance 402 (for example, implementing a search function) and the input end of the message node instance 403, a connection relationship may be established between the output end of the plug-in node instance 402 and the input end of the message node instance 403 (that is, the output content of the plug-in node instance 402 will be provided to the message node instance 403 as a message, and the message node instance 403 may instruct the workflow to present the message according to a predetermined format). With the example embodiments of the present disclosure, the data transfer relationship between the data acquisition node instance and the message node instance may be defined in a simple and effective manner.

In some embodies, the user may select a node instance and set the corresponding presentation attribute. Specifically, in response to determining that a target node instance (such as a data acquisition node instance, a message node instance, a code node instance, a knowledge base node instance, a condition node instance, a plug-in node instance, etc.) among the plurality of node instances is selected, a setting control for setting the presentation attribute of the target node instance is provided. The presentation attribute may indicate, for example, whether the working state of the target node instance and the predetermined conditions for the working state are allowed to be presented during processing the query request. In this way, the user may be allowed to know which node instance in the workflow is currently running, and to know the working state of the node instance, thereby knowing the progress of the digital assistant in answering questions.

Here, the working state may include, for example, a predefined working state and/or a working state determined via data at the input end of the target node instance. The predetermined condition may include, for example, immediate execution, the execution time length of the target node instance satisfies the predetermined time length, and/or the time interval for the workflow to present previous messages exceeds the predetermined time length. The predetermined time length here may be any appropriate predetermined time length, such as 5 seconds, 10 seconds, 15 seconds, etc. The presentation attribute of the workflow may be set in response to receiving a setting request for the setting control. The setting request may include, for example, a triggering operation for setting the control. In some embodiments, the setting control may also include an editing dialog box, and the setting request may also include text input operations on the editing dialog box.

Referring to FIG. 5, which illustrates a schematic diagram of an example 500 of a settings control for a presentation attribute according to some embodiments of the present disclosure. As shown in FIG. 5, example 500 includes control 510. In response to receiving the open operation for the control 510, it may be determined the presentation attribute indicates whether the working state of the target node instance is allowed to be presented during the working of the target node instance. The presentation attribute indicates whether the working state of the target node instance is allowed to be presented during processing of query request. In response to receiving an open operation for control 510, it may be determined that the presentation attribute indicates the working state of the target node instance is allowed to be presented during processing of the query request. In response to receiving a close operation for control 510, it may be determined that the presentation attribute indicates the working state of the target node instance is not allowed to be presented during processing of the query request.

The example 500 may for example include an edit dialog box 520. The user may configure a predefined working state via the edit dialog box 520, and/or configure a template of working state determined via data at the input end of the target node instance. For example, for a model node instance, if the model node instance is used for query, the predefined working state may be “It is being inquired for you”, and the template of the working state determined via the data at the input end of the target node instance may be “Querying XXXX for you” (wherein XXXX is the data at the input end). In this way, more information about individual node instances may be provided during the execution of the workflow, making it easier for users to understand the overall query progress.

In some embodiments, a setting control configured to set an interruption attribute of the workflow is provided. In response to receiving a setting request for an interrupt control (for example, a trigger operation for the interrupt control), the interrupt attribute of the workflow is set. The interruption attribute may indicate, for example, whether interruption of the workflow is allowed during processing of the query request. After the interrupt attribute is set, the workflow may be executed based on the interrupt attribute in response to receiving another query request while the digital assistant is processing the query request. Whether the interruption of workflow being allowed is based on demand. Therefore, during the execution of the workflow, if no reply is output for a long time, the user may interrupt the execution of the workflow, thereby avoiding long waits caused by various exceptions.

Specifically, in response to determining that the interruption attribute indicates that interruption of the workflow is allowed, the workflow may be restarted to use the workflow to process another query request. For example, if query request B is received while processing query request A, and the interruption attribute indicates that the workflow is allowed to be interrupted, the workflow may be restarted (that is, query request A will not be processed any more) and the workflow may be used to process query request B. In response to determining that the interruption attribute indicates that interruption of the workflow is not allowed, the query request is sequentially processed using the workflow. For example, if query request B is received during the processing of query request A, and the interruption attribute indicates that the workflow is not allowed to be interrupted, the workflow may be used to continue processing query request A. In this case, in response to the completion of processing of query request A, the workflow may be restarted and the workflow may be used to process query request B. Alternatively or additionally, query request B may also be ignored (i.e., query request B is not processed).

The above describes the relevant content of configuring the workflow. In some embodiments, after the workflow is integrated in the digital assistant (for example, the workflow is released to be integrated in the digital assistant), if it is determined that the digital assistant receives the query request, the reply to the query request may be acquired using the data acquisition node in the workflow, and the reply may be presented in a predetermined format using the message node in the workflow. The predetermined format may also be, for example, the default format of the application where the digital assistant is located, or the default format corresponding to the integrated digital assistant.

FIGS. 6 to 8 illustrate schematic diagrams of example pages (i.e., examples 600 to 800) according to some embodiments of the present disclosure. Examples 600 to 800 illustrate examples of session query pages for digital assistants. In example 600, a session message 601 may be determined to be a query request in response to receiving the session message 601 from the user. In response to receiving the query request, the digital assistant may use the data acquisition node in the workflow to obtain a reply to the query request. The workflow may include multiple data acquisition nodes, and these multiple data acquisition nodes may, for example, obtain messages of different types (such as text, image, video, etc.). Each data acquisition node may then be connected to its respective message node (that is, the workflow may include multiple message nodes). Each message node presents the message acquired by its upstream data acquisition node in a predetermined format. For example, a first message node may present text 602, a second message node may present multiple videos 610, and a second message node may present text 603, and so on.

In some embodiments, the workflow may also include a node implemented using a model node and/or code node for determining associated query requests. These nodes may determine at least one association requirement associated with the query request. A workflow, for example, may process each association requirement to generate a reply to each association requirement. For example, in example 700, if the query request 701 “What is “XXXX”” is received, it may be determined that “XXXX” is a book, and its corresponding multiple association requirements may include determining the introduction information of this book, determining the introduction information of author of the book and determining the video associated with the book.

The multiple data acquisition nodes in the workflow may in turn acquire data for each association requirement. The message nodes downstream of each data acquisition node may present the received data as a reply to each association requirement. For example, the first message node may present the reply 702 to the association requirement “determining the introduction information of this book”, and the second message node may present the reply 703 to the association requirement “determining the introduction information of the author of this book”, and the third message node may present the reply 704 to the association requirement “determining the video associated with this book”, and so on.

In some embodiments, the workflow may also include a node implemented using a model node and/or code node for determining the user's sub-requirements, and the node may be used to determine at least one sub-requirement included in the query request. The workflow may, for example, process each sub-requirement to generate a reply to each sub-requirement. For example, in example 800, if the query request 801 “XXX YYY” (for example, weather and delicacies in city A) is received, it may be determined that the query request 801 includes the sub-requirement “XXX (weather in city A)” and the sub-requirement “YYY (delicacies in city B)”. The multiple data acquisition nodes in the workflow may then acquire data for each sub-requirement. The message nodes downstream of each data acquisition node may present the received data as a reply to each sub-requirement. For example, the first message node may present the reply 802 to the sub-requirement “XXX”, the second message node may present the reply 803 to the sub-requirement “YYY”, and so on.

To sum up, when processing query requests with the help of workflow, multiple messages are presented using message nodes before the processing of query request is completed. The final reply generated by the workflow may be a summary of these multiple messages. This can realize “one question, multiple replies”, enrich the content obtained by users, and improve the efficiency of acquiring replies.

### Example Process

FIG. 9 illustrates a flow diagram of an example process 900 for managing data output of a workflow in accordance with some embodiments of the present disclosure. Process 900 may be implemented at the assistant creation platform 110. The process 900 is described below with reference to FIG. 1.

At block 910, the assistant creation platform 110 adds a message node instance corresponding to a message node to the workflow in response to receiving a selection request for the message node in a page used to create the workflow, wherein the message node specifies one or more messages output by the workflow.

At block 920, the assistant creation platform 110 presents a message node instance in a second region in the page. The message node instance includes an input end and an output end, the input end is used to receive the message to be output, and the output end is used to specify that the message is presented in a predetermined format by the workflow.

In some embodiments, the process 900 further comprises: presenting a plurality of nodes in the page used to create the workflow, wherein the plurality of nodes further comprise a data acquisition node which includes i) a model node used to invoke a machine learning model or ii) a plug-in node used to invoke a plug-in function, and wherein the workflow includes a data acquisition node instance corresponding to the data acquisition node.

In some embodiments, the process 900 further comprises: for the data acquisition node instance and the message node instance in the workflow, in response to receiving a connection request for coupling the output end of the data acquisition node instance and the input end of the message node instance, establishing a connection relationship between the output end of the data acquisition node instance and the input end of the message node instance.

In some embodiments, the predetermined format is configured to specify at least one of the following of the message: font, font size, color, separator, presentation region, or output mode, wherein the output mode includes a text stream mode and text block mode.

In some embodiments, in response to determining that the input end of the message node instance includes a first input end and a second input end, the predetermined format includes a format specifying a first message from the first input end and the second message from the second input end.

In some embodiments, the process 900 further comprises: receiving at least one input data provided to the workflow in response to receiving a test request for testing the workflow; and providing state data of the message node instance in the workflow, wherein the state data includes at least one of the following: data at the input end of the message node instance, and data at the output end of the message node instance.

In some embodiments, the process 900 further comprises: in response to receiving a release request, releasing the workflow so that the workflow is integrated in a digital assistant.

In some embodiments, the workflow is integrated in the digital assistant, and the process 900 further comprises: in response to determining that the digital assistant receives a query request, using the data acquisition node in the workflow to acquire a reply to the query request; and presenting the reply according to the predetermined format using the message node in the workflow.

In some embodiments, the process 900 further comprises: providing a setting control configured to set an interruption attribute of the workflow, wherein the interruption attribute indicates whether interruption of the workflow is allowed during processing of the query request; and in response to receiving a setting request for a interrupt control, setting the interrupt attribute of the workflow.

In some embodiments, the process 900 further comprises: in response to receiving another query request during the processing of the query request by the digital assistant, executing the workflow based on the interruption attribute, including at least one of the following: in response to determining that the interruption attribute indicates that interruption of the workflow is allowed, restarting the workflow to utilize the workflow to process the another query request; and in response to determining that the interruption attribute indicates that interruption of the workflow is not allowed, sequentially processing the query request using the workflow.

In some embodiments, the workflow includes a plurality of node instances of the plurality of nodes, and the process 900 further comprises: in response to determining that a target node instance of the plurality of node instances is selected, providing a settings control configured to set a presentation attribute of the target node instance, wherein the presentation attribute indicates whether the working state of the target node instance and the predetermined conditions for the working state are allowed to be presented during processing the query request; and setting the presentation attribute of the workflow in response to receiving a setting request for the setting control.

In some embodiments, the process 900 further comprises: in response to determining that the predetermined condition is satisfied, presenting the working state of the target node instance, wherein the working state includes at least one of the following: a predefined working state, and a working state determined via data at the input end of the target node instance.

In some embodiments, the workflow includes an end node instance, and the message node instance is located upstream from the end node instance, and the message node instance is configured to specify a first reply to the query request output by the workflow, and the end node instance is configured to specify a second reply to the query request output by the workflow, the second reply is generated based on the first reply.

In some embodiments, the workflow further comprises a start node instance, and the message node is located between the start node instance and the end node instance.

In some embodiments, the message node is presented in a first region in the page, or the message node is presented in response to an adding request for adding a node to the workflow received in a second region in the page.

### Example Apparatus and Device

The embodiments of the present disclosure also provide corresponding apparatus for implementing the above methods or processes. FIG. 10 shows a structural schematic block diagram of an example apparatus 1000 for managing data output of a workflow according to some embodiments of the present disclosure. The apparatus 1000 may be included, for example, in assistant creation platform 110 in FIG. 1. Each module/component in the apparatus 1000 may be implemented by hardware, software, firmware, or any combination thereof.

As shown in the figures, the apparatus 1000 further comprises an instance adding module 1010 configured to add a message node instance corresponding to the message node to the workflow in response to receiving a selection request for a message node in a page used to create the workflow, wherein the message node specifies the message output by the workflow. The apparatus 1000 further comprises an instance presenting module 1020 configured to present the message node instance in the page, wherein the message node instance includes an input end and an output end, the input end is used to receive a message to be output, and the output end is used to specify that the message is presented in a predetermined format by the workflow.

In some embodiments, the plurality of nodes further comprise a data acquisition node which includes a model node used to invoke a machine learning model or a plug-in node used to invoke a plug-in function, and the workflow includes a data acquisition node instance corresponding to the data acquisition node.

In some embodiments, the apparatus 1000 further comprises a connection relationship establishing module, which is configured for the data acquisition node instance and the message node instance in the workflow, in response to receiving a connection request for connecting the output end of the data acquisition node instance and the input end of the message node instance, establishing a connection relationship between the output end of the data acquisition node instance and the input end of the message node instance.

In some embodiments, the predetermined format is configured to specify at least one of the following of the message: font, font size, color, separator, presentation region, and output mode, wherein the output mode includes a text stream mode and text block mode.

In some embodiments, in response to determining that the input end of the message node instance includes a first input end and a second input end, the predetermined format includes a format specifying a first message from the first input end and the second message from the second input end.

In some embodiments, the apparatus 1000 further comprises a input data receiving module, which is configured for receiving at least one input data provided to the workflow in response to receiving a test request for testing the workflow; and a state data providing module, which is configured for providing state data of the message node instance in the workflow, wherein the state data includes at least one of the following: data at the input end of the message node instance, and data at the output end of the message node instance.

In some embodiments, the apparatus 1000 further comprises an integrating module, which is configured in response to receiving a release request, releasing the workflow so that the workflow is integrated in a digital assistant.

In some embodiments, the apparatus 1000 further comprises: a replay acquiring module, which is configured for in response to determining that the digital assistant receives a query request, utilizing the data acquisition node in the workflow to acquire a reply to the query request; and a reply presenting module, which is configured for presenting the reply according to the predetermined format using the message node in the workflow.

In some embodiments, the apparatus 1000 further comprises: a first setting control providing module, which is configured for providing a setting control configured to set an interruption attribute of the workflow, wherein the interruption attribute indicates whether interruption of the workflow is allowed during processing of the query request; and a interrupt attribute setting module, which is configured for in response to receiving a setting request for a interrupt control, setting the interrupt attribute of the workflow.

In some embodiments, the apparatus 1000 further comprises a executing module, which is configured for in response to receiving another query request during the processing of the query request by the digital assistant, executing the workflow based on the interruption attribute, including at least one of the following: in response to determining that the interruption attribute indicates that interruption of the workflow is allowed, restarting the workflow to utilize the workflow to process the another query request; and in response to determining that the interruption attribute indicates that interruption of the workflow is not allowed, sequentially processing the query request using the workflow.

In some embodiments, the workflow includes a plurality of node instances, and the apparatus 1000 further comprises: a second setting control providing module, which is configured for in response to determining that a target node instance of the plurality of node instances is selected, providing a setting control configured to set a presentation attribute of the target node instance, wherein the presentation attribute indicates whether the working state of the target node instance and the predetermined conditions for the working state are allowed to be presented during processing the query request; and a presentation attribute setting module, which is configured for setting the presentation attribute of the workflow in response to receiving a setting request for the setting control.

In some embodiments, the apparatus 1000 further comprises a working state presenting module, which is configured for in response to determining that the predetermined condition is satisfied, presenting the working state of the target node instance, wherein the working state includes at least one of the following: a predefined working state, and a working state determined via data at the input end of the target node instance.

In some embodiments, the workflow includes a start node instance and an end node instance, and the message node instance is located upstream of the end node instance, and the message node instance is configured to specify a first reply to the query request output by the workflow, and the end node instance is configured to specify a second reply to the query request output by the workflow, the second reply is generated based on the first reply.

The units and/or modules included in the apparatus 1000 may be implemented in various ways, including software, hardware, firmware, or any combination thereof. In some embodiments, one or more units and/or modules may be implemented using software and/or firmware, such as machine-executable instructions stored on a storage medium. In addition to or as an alternative to machine-executable instructions, part or all of the units and/or modules in apparatus 1000 may be implemented, at least in part, by one or more hardware logic components. By way of example, and not limitation, exemplary types of hardware logic components that may be used include field programmable gate arrays (FPGAs), application specific integrated circuits (ASICs), application specific standard products (ASSPs), systems on chip (SOCs), complex programmable logic devices (CPLDs), etc.

It should be understood that one or more steps in the above method may be performed by an appropriate electronic device or combination of electronic devices. Such an electronic device or combination of electronic devices may include, for example, the assistant creation platform 110 and/or the assistant application platform 130 in FIG. 1.

FIG. 11 shows a block diagram of an electronic device 1100 in which one or more embodiments of the present disclosure may be implemented. It should be understood that the electronic device 1100 shown in FIG. 11 is merely exemplary and should not constitute any limitation on the functionality and scope of the embodiments described herein. The electronic device 1100 shown in FIG. 11 can be used to implement the assistant creation platform 110, the assistant application platform 130 of FIG. 1, and/or the apparatus 1000 of FIG. 10.

As shown in FIG. 11, the electronic device 1100 is in the form of a general-purpose electronic device. The components of electronic device 1100 may include, but are not limited to, one or more processors or processing units 1110, memory 1120, storage device 1130, one or more communication units 1140, one or more input devices 1150, and one or more output devices 1160. The processing unit 1110 may be a real or virtual processor and can perform various processes according to a program stored in the memory 1120. In a multi-processor system, the multiple processing units execute computer-executable instructions in parallel to improve the parallel processing capability of the electronic device 1100.

The electronic device 1100 typically includes a plurality of computer storage media. Such media may be any available media that is accessible to electronic device 1100, including but not limited to volatile and nonvolatile media, removable and non-removable media. The memory 1120 may be a volatile memory (e.g., registers, cache, random access memory (RAM)), a nonvolatile memory (e.g., read only memory (ROM), electrically erasable programmable read only memory (EEPROM), flash memory) or some combination thereof. The storage device 1130 may be a removable or non-removable medium and may include machine-readable media such as a flash drive, a magnetic disk, or any other medium that may be capable of storing information and/or data and may be accessible in electronic device 1100.

The electronic device 1100 may further comprise additional removable/non-removable, volatile/non-volatile storage media. Although not shown in FIG. 11, a disk drive may be provided for reading from or writing to a removable, non-volatile disk (e.g., a “floppy disk”) and optical disk drive may be provided for reading from or writing to a removable, non-volatile optical disk. In these cases, each drive may be connected to the bus (not shown) by one or more data media interfaces. The memory 1120 may include a computer program product 1125 having one or more program modules configured to perform various methods or actions of various embodiments of the present disclosure.

The communication unit 1140 communicates with other electronic devices through communication media. Additionally, the functionality of the components of electronic device 1100 may be implemented with a single computing cluster or multiple computing machines capable of communicating over a communications connection. Accordingly, the electronic device 1100 may operate in a networked environment using a logical connection to one or more other servers, a network personal computer (PC), or another network node.

The input device 1150 may be one or more input devices, such as a mouse, keyboard, trackball, etc. The output device 1160 may be one or more output devices, such as a display, speakers, printer, etc. The electronic device 1100 may also communicate with one or more external devices (not shown), such as storage devices, display devices, etc., through the communication unit 1140 as needed, and with one or more devices that enable the user to interact with the electronic device 1100, or with any device (e.g., network card, modem, etc.) that enables electronic device 1100 to communicate with one or more other electronic devices. Such communication may be performed via an input/output (I/O) interface (not shown).

According to an exemplary implementation of the present disclosure, there is provided a computer-readable storage medium having a computer program stored thereon, the computer program, when executed by a processor, causes the processor to perform operations that implements the above method. According to an exemplary implementation of the present disclosure, there is provide a computer program product, the computer program product is tangibly stored on a non-transitory computer-readable medium and includes computer-executable instructions, and the computer-executable instructions are executed by a processor to implement the method described above.

Aspects of the present disclosure are described herein with reference to flowchart illustrations and/or block diagrams of methods, apparatus, devices and computer program products implemented in accordance with the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processing unit of a general-purpose computer, a special-purpose computer, or other programmable data processing apparatus, thereby producing a machine such that, when the instructions executed by the processing unit of the computer or other programmable data processing apparatus, an apparatus that implements the functions/actions specified in one or more blocks of the flowcharts and/or block diagrams is produced. These computer-readable program instructions may also be stored in a computer-readable storage medium. These instructions cause the computer, programmable data processing device and/or other devices to work in a specific manner. Therefore, the computer-readable medium storing the instructions includes an article of manufacture that includes instructions that implement aspects of the functions/acts specified in one or more blocks of the flowcharts and/or block diagrams.

The computer-readable program instructions may be loaded onto a computer, other programmable data processing apparatus, or other device, causing a series of operating steps to be performed on the computer, other programmable data processing apparatus, or other devices to produce a computer-implemented process, thereby, instructions executed on a computer, other programmable data processing apparatus, or other device implement the functions/actions specified in one or more blocks of the flowcharts and/or block diagrams.

The flowcharts and block diagrams in the figures illustrate the architecture, functionality, and operation of possible implementations of systems, methods, and computer program products according to various implementations of the present disclosure. In this regard, each block in the flowchart or block diagrams may represent a module, program segment, or portion of instructions that contains one or more executable functions for implementing the specified logical functions instruction. In some alternative implementations, the functions noted in the blocks may occur out of the order noted in the figures. For example, two consecutive blocks may actually execute substantially in parallel, or they may sometimes execute in the reverse order, depending on the functionality involved. It will also be noted that each block of the block diagram and/or flowchart illustration, and combinations of blocks in the block diagram and/or flowchart illustration, may be implemented by special purpose hardware-based systems that perform the specified functions or acts or can be implemented using a combination of specialized hardware and computer instructions.

Implementations of the present disclosure have been described above. The above description is illustrative, not exhaustive, and is not limited to the disclosed implementations. Many modifications and variations will be apparent to those skilled in the art without departing from the scope and spirit of the described implementations. The terminology used in this description is chosen to best explain the principles, practical applications, or improvements to technology in the market, or to enable other persons of ordinary skill in this field to understand the various implementations disclosed in this description.

1. A method for managing data output of a workflow, comprising:
adding a message node instance corresponding to a message node to the workflow in response to receiving a selection request for the message node in a page used to create the workflow, wherein the message node specifies one or more messages output by the workflow; and
presenting the message node instance in the page, wherein the message node instance includes an input end and an output end, and wherein the input end is used to receive the message to be output, and the output end is used to specify that the message is presented in a predetermined format by the workflow.

2. The method of claim 1, further comprising: presenting a plurality of nodes in the page used to create the workflow, wherein the plurality of nodes further comprise a data acquisition node that includes i) a model node used to invoke a machine learning model or ii) a plug-in node used to invoke a plug-in function, and wherein the workflow includes a data acquisition node instance corresponding to the data acquisition node.

3. The method of claim 2, further comprising: for the data acquisition node instance and the message node instance in the workflow, in response to receiving a connection request for coupling the output end of the data acquisition node instance and the input end of the message node instance, establishing a connection relationship between the output end of the data acquisition node instance and the input end of the message node instance.

4. The method of claim 1, wherein the predetermined format is configured to specify at least one of the following of the message: font, font size, color, separator, presentation region, or output mode, wherein the output mode includes a text stream mode and text block mode.

5. The method of claim 1, further comprising: in response to determining that the input end of the message node instance includes a first input end and a second input end, the predetermined format includes a format specifying a first message from the first input end and the second message from the second input end.

6. The method of claim 1, further comprising:
receiving at least one input data provided to the workflow in response to receiving a test request for testing the workflow; and
providing state data of the message node instance in the workflow, wherein the state data includes at least one of the following: data at the input end of the message node instance or data at the output end of the message node instance.

7. The method of claim 1, further comprising: in response to receiving a release request, releasing the workflow so that the workflow is integrated in a digital assistant.

8. The method of claim 1, wherein the workflow is integrated in the digital assistant, and the method further comprises:
in response to determining that the digital assistant receives a query request, using the data acquisition node in the workflow to acquire a reply to the query request; and
presenting the reply according to the predetermined format using the message node in the workflow.

9. The method of claim 8, further comprising:
providing a settings control configured to set an interruption attribute of the workflow, wherein the interruption attribute indicates whether interruption of the workflow is allowed during processing of the query request; and
in response to receiving a setting request for an interrupt control, setting the interrupt attribute of the workflow.

10. The method of claim 9, further comprising: in response to receiving another query request during the processing of the query request by the digital assistant, executing the workflow based on the interruption attribute, including at least one of the following:
in response to determining that the interruption attribute indicates that interruption of the workflow is allowed, restarting the workflow to utilize the workflow to process the another query request; and
in response to determining that the interruption attribute indicates that interruption of the workflow is not allowed, sequentially processing the query request using the workflow.

11. The method of claim 2, wherein the workflow includes a plurality of node instances of the plurality of nodes, and the method further comprises:
in response to determining that a target node instance of the plurality of node instances is selected, providing a settings control configured to set a presentation attribute of the target node instance, wherein the presentation attribute indicates whether the working state of the target node instance and the predetermined conditions for the working state are allowed to be presented during processing the query request; and
setting the presentation attribute of the workflow in response to receiving a setting request for the settings control.

12. The method of claim 11, further comprising: in response to determining that the predetermined condition is satisfied, presenting the working state of the target node instance, wherein the working state includes at least one of the following: a predefined working state, and a working state determined via data at the input end of the target node instance.

13. The method of claim 8, wherein the workflow includes an end node instance, and the message node instance is located upstream from the end node instance, and the message node instance is configured to specify a first reply to the query request output by the workflow, and the end node instance is configured to specify a second reply to the query request output by the workflow, the second reply is generated based on the first reply.

14. The method of claim 13, wherein the workflow further comprises a start node instance, and the message node is located between the start node instance and the end node instance.

15. The method of claim 1, wherein: the message node is presented in a first region in the page, or the message node is presented in response to an adding request for adding a node to the workflow received in a second region in the page.

16. An electronic device comprising:
at least one processing unit; and
at least one memory coupled to the at least one processing unit and storing instructions executed by the at least one processing unit, the instructions when executed by the at least one processing unit causes the electronic device to perform operations comprising:
adding a message node instance corresponding to a message node to the workflow in response to receiving a selection request for the message node in a page used to create the workflow, wherein the message node specifies one or more messages output by the workflow; and
presenting the message node instance in the page, wherein the message node instance includes an input end and an output end, and wherein the input end is used to receive the message to be output, and the output end is used to specify that the message is presented in a predetermined format by the workflow.

17. The electronic device of claim 16, wherein presenting a plurality of nodes in the page used to create the workflow, wherein the plurality of nodes further comprise a data acquisition node that includes i) a model node used to invoke a machine learning model or ii) a plug-in node used to invoke a plug-in function, and wherein the workflow includes a data acquisition node instance corresponding to the data acquisition node.

18. The electronic device of claim 17, wherein for the data acquisition node instance and the message node instance in the workflow, in response to receiving a connection request for coupling the output end of the data acquisition node instance and the input end of the message node instance, establishing a connection relationship between the output end of the data acquisition node instance and the input end of the message node instance.

19. The electronic device of claim 16, wherein the predetermined format is configured to specify at least one of the following of the message: font, font size, color, separator, presentation region, or output mode, wherein the output mode includes a text stream mode and text block mode.

20. A non-transitory computer-readable storage medium having a computer program stored thereon, the computer program, when executed by a processor, causes the processor to perform operations comprising:
adding a message node instance corresponding to a message node to the workflow in response to receiving a selection request for the message node in a page used to create the workflow, wherein the message node specifies one or more messages output by the workflow; and
presenting the message node instance in the page, wherein the message node instance includes an input end and an output end, and wherein the input end is used to receive the message to be output, and the output end is used to specify that the message is presented in a predetermined format by the workflow.
